(19) United States
(12) Patent Application Publication
(10) Pub. No.: US 2026/0341997 A1
(43) Pub. Date: Oct. 29, 2026

(54) POWER PLUG

(71) Applicant: Chicony Power Technology Co., Ltd., New Taipei City (TW)

(72) Inventors: Yu-Jan LIN, New Taipei City (TW); Wei-Hsiang TING, New Taipei City (TW)

(21) Appl. No.: 19/298,221

(22) Filed: Aug. 13, 2025

(30) Foreign Application Priority Data
Apr. 24, 2025 (TW) 114115593

(51) Int. Cl. H01R 13/426; H01R 13/04; H01R 13/502; H01R 103/00

(52) U.S. Cl. CPC H01R 13/426; H01R 13/04; H01R 13/502; H01R 2103/00

(57) ABSTRACT

A power plug includes a base, a flat spring, and a ground pin. The base is provided with a receiving groove. A bottom of the receiving groove is provided with two fixing holes. The flat spring is disposed in the receiving groove, and includes a body and two fixing sheets. The body includes two through holes and a bent portion located between the two through holes and protruding in a direction away from the base. The two fixing sheets respectively extend from two opposite sides of the body toward the base, and respectively abut against sidewalls of the two fixing holes. The ground pin includes a ground member and a sliding member. The sliding member is moveably disposed in the receiving groove and contacts the flat spring.

### RELATED APPLICATIONS

This application claims priority to Taiwan Application Serial Number 114115593, filed Apr. 24, 2025, the disclosure of which is incorporated herein by reference in its entirety.

### BACKGROUND

### Technical Field

The present invention relates to a power plug, in particular to a power plug with a movable ground pin.

### Description of Related Art

Although a current power plug with a movable ground pin reduces a size of the power plug and is easy to carry, it requires a fixing plate and screws to fix a spring that matches the ground pin, which increases assembly time and cost of the power plug.

### SUMMARY

In order to solve the aforementioned technical problem, the present invention provides a power plug, which includes a base, a flat spring, and a ground pin. The base is provided with a receiving groove. A bottom of the receiving groove is provided with a first fixing hole and a second fixing hole. The flat spring is disposed in the receiving groove and includes a body, a first fixing sheet, and a second fixing sheet. The body includes two through holes and a bent portion located between the two through holes and protruding in a direction away from the base. The first fixing sheet and the second fixing sheet respectively extend from a first side and a second side of the body toward the base and respectively abut against a sidewall of the first fixing hole and a sidewall of the second fixing hole. The first side and the second side are opposite sides of the body. The ground pin includes a ground member and a sliding member. The sliding member is movably disposed in the receiving groove and contacts the flat spring.

In one or more embodiments, an angle between the first fixing sheet and the body and an angle between the second fixing sheet and the body are greater than 90 degrees and less than or equal to 110 degrees.

In one or more embodiments, the flat spring further includes a first locking sheet and a second locking sheet. The first locking sheet and the second locking sheet extend from a third side of the body toward the base and respectively abut against the sidewall of the first fixing hole and the sidewall of the second fixing hole. The third side is connected between the first side and the second side.

In one or more embodiments, the first locking sheet is substantially parallel to the sidewall of the first fixing hole, and the second locking sheet is substantially parallel to the sidewall of the second fixing hole.

In one or more embodiments, a sidewall of the receiving groove is provided with a slider, and the sliding member is provided with a chute corresponding to the slider.

In one or more embodiments, the chute has an open end, and two opposite sidewalls of the chute are inclined outward at the open end.

In one or more embodiments, a length of the two through holes is substantially the same as a distance between two opposite ends of the bent portion.

In one or more embodiments, a bottom surface of the sliding member is provided with a moving groove and a positioning groove. The bent portion of the flat spring is movably disposed in the moving groove. The positioning groove is located at an end of the moving groove and is configured to position the bent portion at the end of the moving groove.

In one or more embodiments, a depth of the positioning groove is greater than a depth of the moving groove.

In one or more embodiments, the depth of the moving groove is less than a maximum vertical distance between the bent portion and the body, and the depth of the positioning groove is substantially equal to the maximum vertical distance.

In one or more embodiments, the bent portion abuts against a bottom of the positioning groove.

In one or more embodiments, the power plug further includes a cover. The cover is disposed on the base and covers the sliding member located in the receiving groove. A bottom surface of the cover is provided with a limiting member. A top surface of the sliding member is provided with a limiting groove. The limiting member is movably disposed in the limiting groove.

In one or more embodiments, the ground member is connected to an end of the sliding member and is substantially perpendicular to the sliding member.

In one or more embodiments, a distance between the first side and the second side of the body is equal to a distance between the sidewall of the first fixing hole and the sidewall of the second fixing hole.

In one or more embodiments, the bent portion includes two inclined portions connected to each other, and an angle between the two inclined portions is an obtuse angle.

### BRIEF DESCRIPTION OF THE DRAWINGS

FIG. 1 is a schematic diagram of a power plug according to an embodiment of the present invention.

FIG. 2 is an exploded view of the power plug in FIG. 1.

FIG. 3 is a top view of the power plug in FIG. 1.

FIG. 4 is a sectional view of the power plug in FIG. 3 taken along a line 4-4’.

FIG. 5 is another top view of the power plug in FIG. 1, wherein the ground pin is fully inserted into the receiving groove.

FIG. 6 is a sectional view of the power plug in FIG. 5 taken along a line 6-6’.

FIG. 7 is a sectional view of the power plug in FIG. 5 taken along a line 7-7’.

FIG. 8 is a schematic diagram of a flat spring and a portion of a base in FIG. 2.

FIG. 9 is a schematic diagram of a combination of the flat spring and the base in FIG. 2 viewed from another angle.

FIG. 10 is a schematic diagram of the ground pin in FIG. 2 viewed from another angle.

### DETAILED DESCRIPTION

The embodiments of the present invention will be described clearly and completely below with reference to the accompanying drawings. For the sake of clarity, numerous practical details are described below. However, one skilled in the art may practice the present invention without one or more of these practical details. Accordingly, these practical details should not be construed as limiting the present invention. In addition, the terms such as "first" and "second" mentioned below do not represent any order, quantity, or importance, but are only used to distinguish different parts.

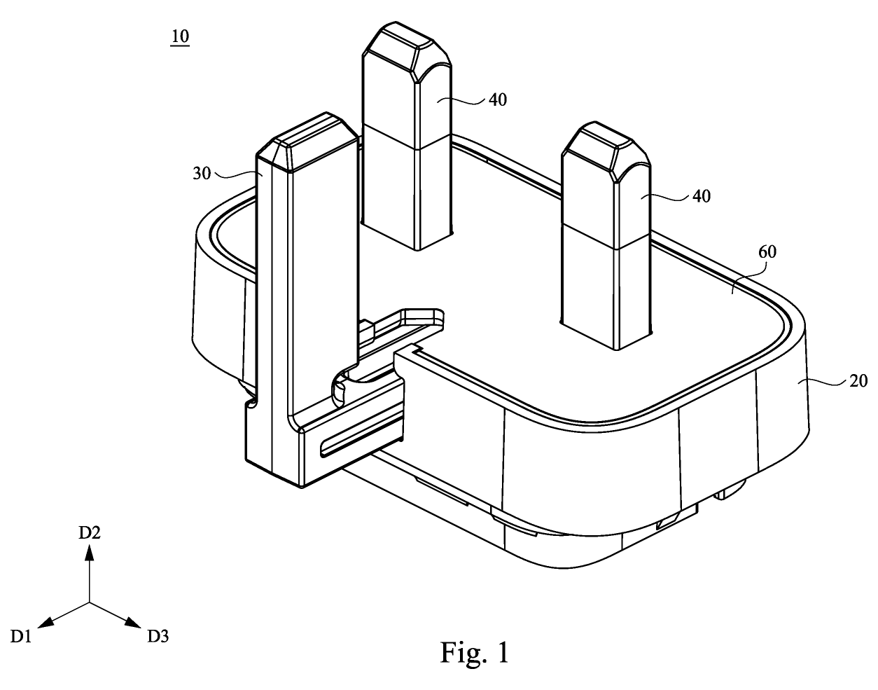

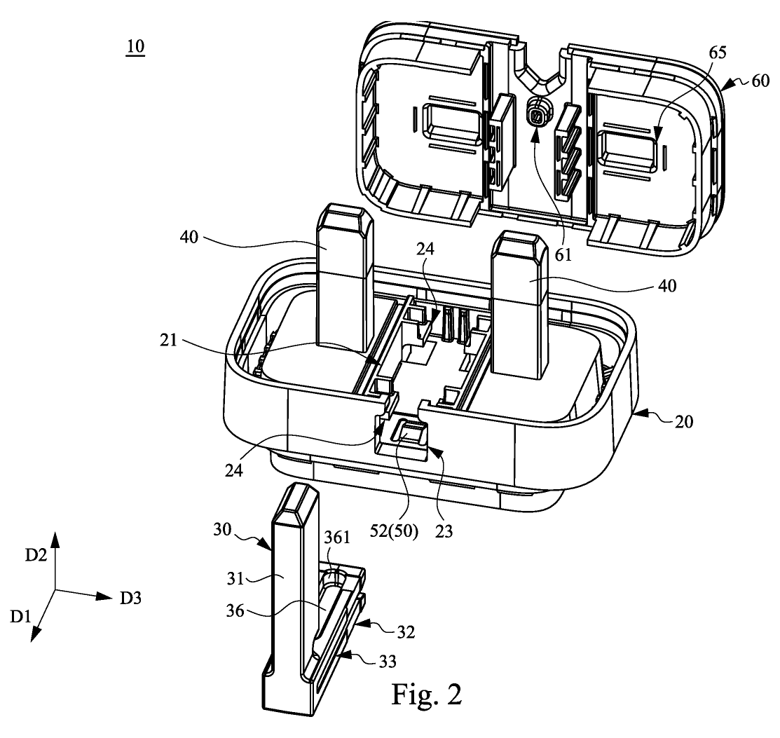

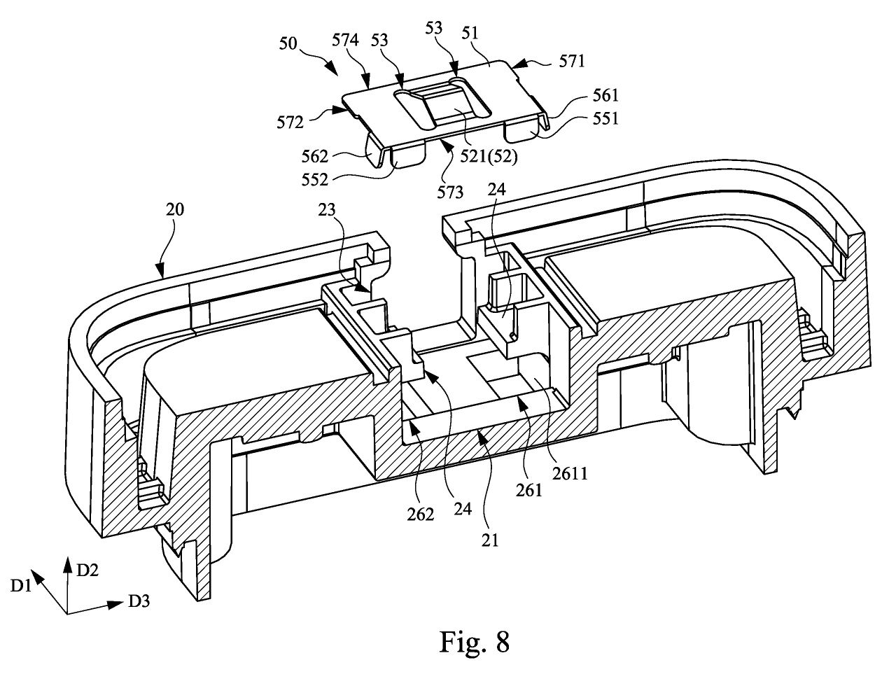

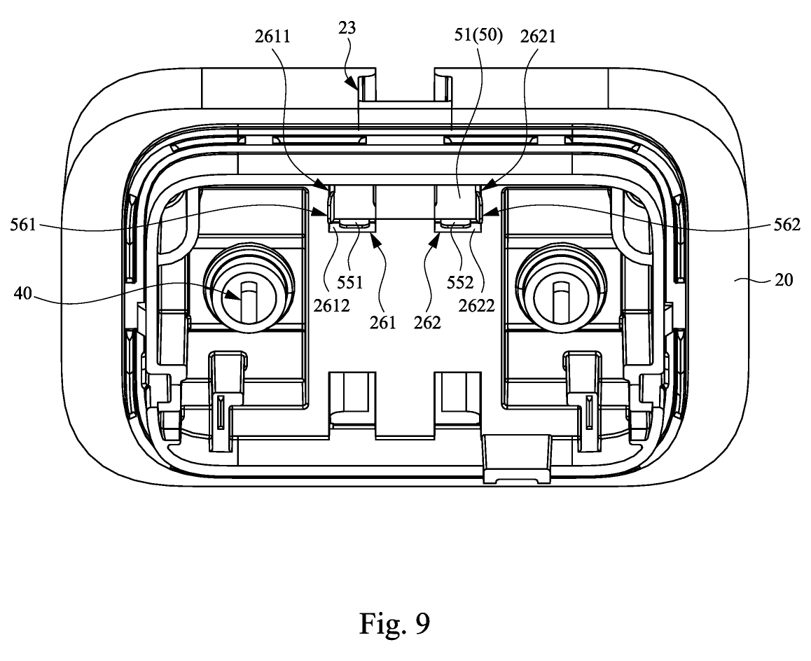

Please refer to FIG. 1 and FIG. 2. FIG. 1 is a schematic diagram of a power plug 10 according to an embodiment of the present invention. FIG. 2 is an exploded view of the power plug 10 in FIG. 1. The power plug 10 includes a base 20, a flat spring 50, and a ground pin 30. The base 20 is provided with a receiving groove 21. The flat spring 50 is disposed in the receiving groove 21. Specifically, please refer to FIG. 8 and FIG. 9, a bottom of the receiving groove 21 is provided with a first fixing hole 261 and a second fixing hole 262. The flat spring 50 includes a body 51, a first fixing sheet 561, and a second fixing sheet 562. The body 51 includes two through holes 53 and a bent portion 52 located between the two through holes 53 and protruding in a direction away from the base 20. The first fixing sheet 561 and the second fixing sheet 562 respectively extend from a first side 571 and a second side 572 of the body 51 toward the base 20. The first side 571 and the second side 572 are opposite sides of the body 51. The first fixing sheet 561 and the second fixing sheet 562 are respectively inserted into the first fixing hole 261 and the second fixing hole 262, and respectively abut against a first sidewall 2611 of the first fixing hole 261 and a first sidewall 2621 of the second fixing hole 262, so that the flat spring 50 is fixed to the bottom of the receiving groove 21. Accordingly, the power plug 10 of the present invention does not require any fixing plates or screws to fix the flat spring 50, thereby reducing the number of required parts and thus reducing costs, and simplifying an assembly process and thus improving production efficiency.

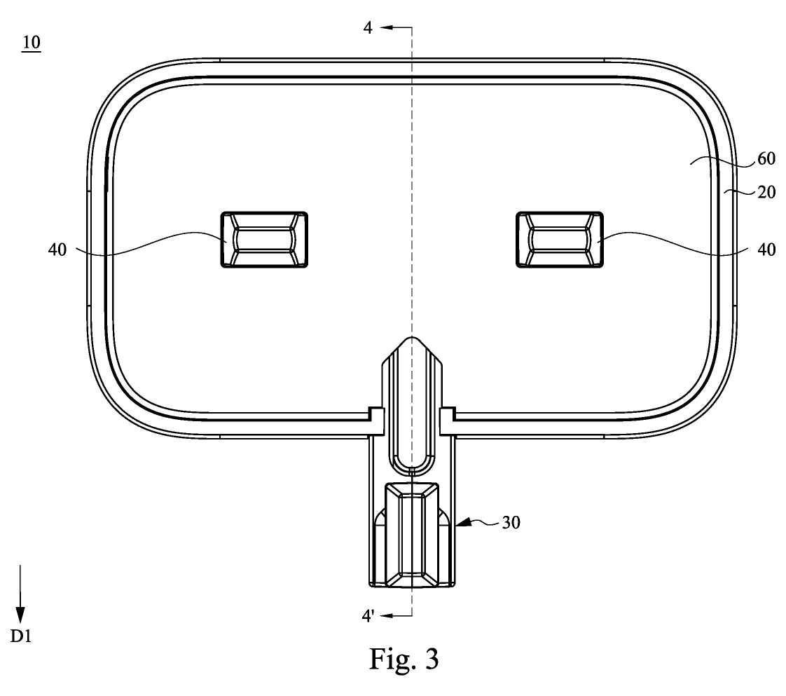

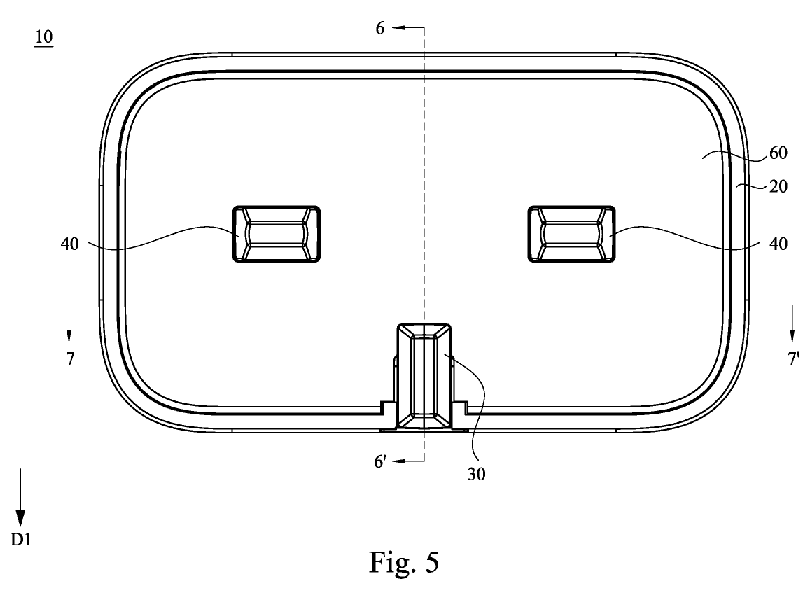

Please refer to FIG. 2. The ground pin 30 includes a ground member 31 and a sliding member 32. The sliding member 32 is movably disposed in the receiving groove 21, so that the ground pin 30 can be moved along a first direction D1 to an extended position shown in FIG. 3, and can also be moved along an opposite direction of the first direction D1 to a retracted position shown in FIG. 5. Specifically, a sidewall of the receiving groove 21 is provided with an opening 23. The sliding member 32 enters the receiving groove 21 through the opening 23 and moves within the receiving groove 21 along the first direction D1 or the opposite direction thereof. The sliding member 32 contacts the flat spring 50. Specifically, the sliding member 32 is disposed above the flat spring 50, and a lower surface of the sliding member 32 abuts against the bent portion 52 of the flat spring 50, thereby further fixing the flat spring 50. The ground member 31 is connected to an end of the sliding member 32 and is substantially perpendicular to the sliding member 32. The ground pin 30 may be made of a conductive material.

Please refer to FIG. 1, the power plug 10 may be a British standard plug and may be applied to a power adapter, but is not limited thereto. The power plug 10 may further include two power pins 40 disposed on the base 20. Specifically, the two power pins 40 are combined with the base 20 by insert molding. The two power pins 40 include a live pin and a neutral pin. The receiving groove 21 may be located between the two power pins 40.

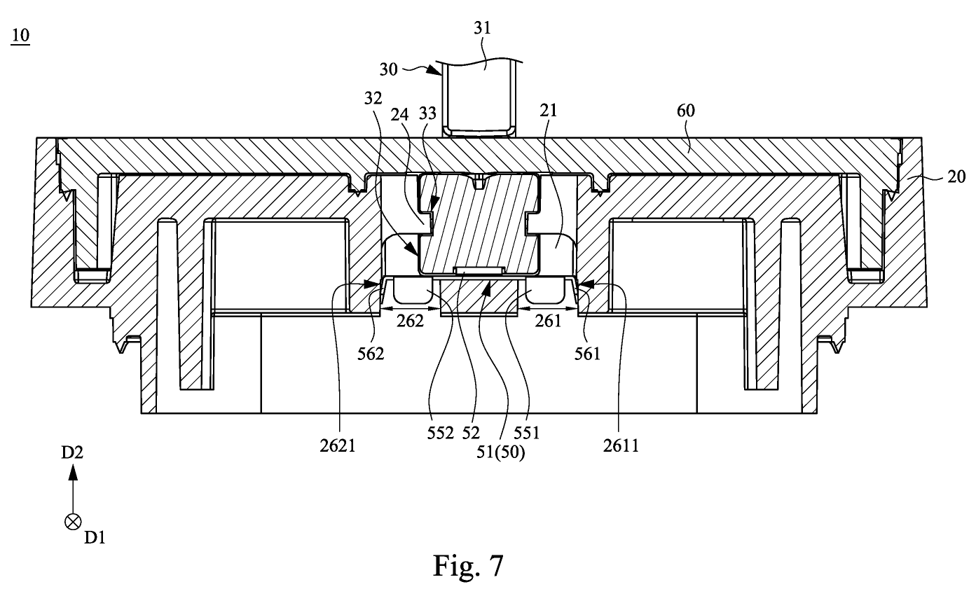

Please refer to FIG. 8, in an embodiment, an angle between the first fixing sheet 561 and the body 51 is greater than 90 degrees and less than or equal to 110 degrees, and/or an angle between the second fixing sheet 562 and the body 51 is greater than 90 degrees and less than or equal to 110 degrees. Specifically, please refer to FIG. 7 and FIG. 8, the flat spring 50 may be an elastic member made of a conductive material. A distance between the first side 571 and the second side 572 of the body 51 is equal to or slightly less than a distance between the first sidewall 2611 of the first fixing hole 261 and the first sidewall 2621 of the second fixing hole 262. An angle between the first fixing sheet 561 and a lower surface of the body 51 is greater than 90 degrees and less than or equal to 110 degrees, and an angle between the second fixing sheet 562 and the lower surface of the body 51 is greater than 90 degrees and less than or equal to 110 degrees. Please refer to FIG. 7 to FIG. 9, when the first fixing sheet 561 is inserted into the first fixing hole 261, a reaction force generated by the first sidewall 2611 of the first fixing hole 261 causes the first fixing sheet 561 to bend toward the body 51. Simultaneously, an elastic restoring force generated by the first fixing sheet 561 acts on the first sidewall 2611. When the second fixing sheet 562 is inserted into the second fixing hole 262, a reaction force generated by the first sidewall 2621 of the second fixing hole 262 causes the second fixing sheet 562 to bend toward the body 51. Simultaneously, an elastic restoring force generated by the second fixing sheet 562 acts on the first sidewall 2621. Accordingly, the flat spring 50 is more firmly fixed to the bottom of the receiving groove 21.

Please refer to FIG. 7 to FIG. 9, in an embodiment, the flat spring 50 further includes a first locking sheet 551 and a second locking sheet 552. The first locking sheet 551 and the second locking sheet 552 extend from a third side 573 of the body 51 of the flat spring 50 toward the base 20. The third side 573 is connected between the first side 571 and the second side 572. The first locking sheet 551 and the second locking sheet 552 are respectively inserted into the first fixing hole 261 and the second fixing hole 262, and respectively abut against a second sidewall 2612 of the first fixing hole 261 and a second sidewall 2622 of the second fixing hole 262, so that the flat spring 50 is more firmly fixed to the bottom of the receiving groove 21.

Please refer to FIG. 8 and FIG. 9, in an embodiment, the first locking sheet 551 is substantially parallel to the second sidewall 2612 of the first fixing hole 261, and the second locking sheet 552 is substantially parallel to the second sidewall 2622 of the second fixing hole 262. Specifically, the first locking sheet 551 and the second locking sheet 552 are substantially perpendicular to the body 51. Since the first locking sheet 551 and the second locking sheet 552 are located on the third side 573 of the body 51, and a fourth side 574 of the body 51 is not provided with any locking sheets, if an angle between the first locking sheet 551 and the body 51 or an angle between the second locking sheet 552 and the body 51 is greater than 90 degrees, an elastic restoring force exerted by the first locking sheet 551 or the second locking sheet 552 on the second sidewall 2612 or 2622 is too large, causing the fourth side 574 of the body 51 of the assembled flat spring 50 to move upward away from the bottom of the receiving groove 21, thereby causing the flat spring 50 to separate from the base 20.

In the aforementioned embodiments, the first fixing hole 261 and the second fixing hole 262 are rectangular holes, and the first fixing sheet 561, the second fixing sheet 562, the first locking sheet 551, and the second locking sheet 552 are flat sheets, but are not limited thereto. In other embodiments, the first fixing hole 261 and the second fixing hole 262 may be circular holes or elliptical holes, and the first fixing sheet 561, the second fixing sheet 562, the first locking sheet 551, and the second locking sheet 552 may be arc-shaped sheets and abut against a sidewall of the first fixing hole 261 or a sidewall of the second fixing hole 262.

Please refer to FIG. 8, in an embodiment, a length of the two through holes 53 is substantially the same as a distance between two opposite ends of the bent portion 52. In this embodiment, the bent portion 52 includes two inclined portions 521 connected to each other. An angle between the two inclined portions 521 is an obtuse angle, but is not limited thereto. In other embodiments, the angle between the two inclined portions 521 may be a right angle or an acute angle.

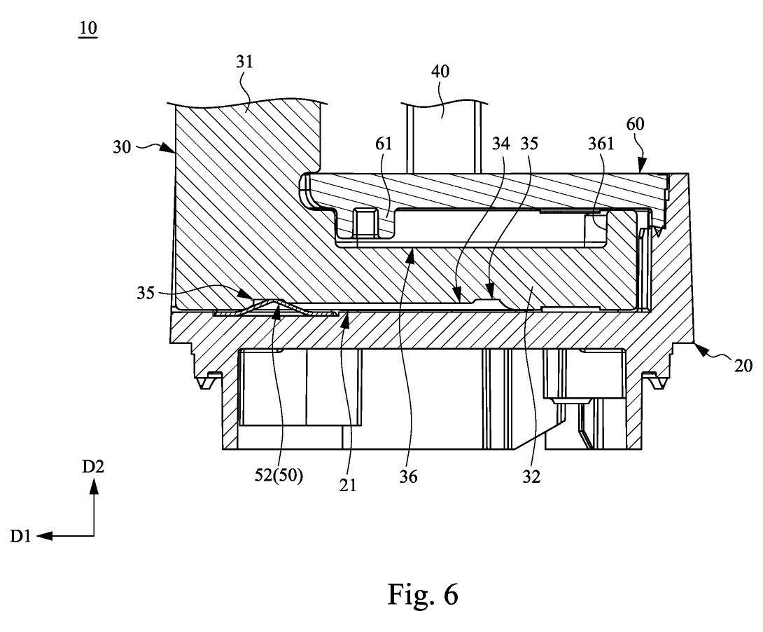

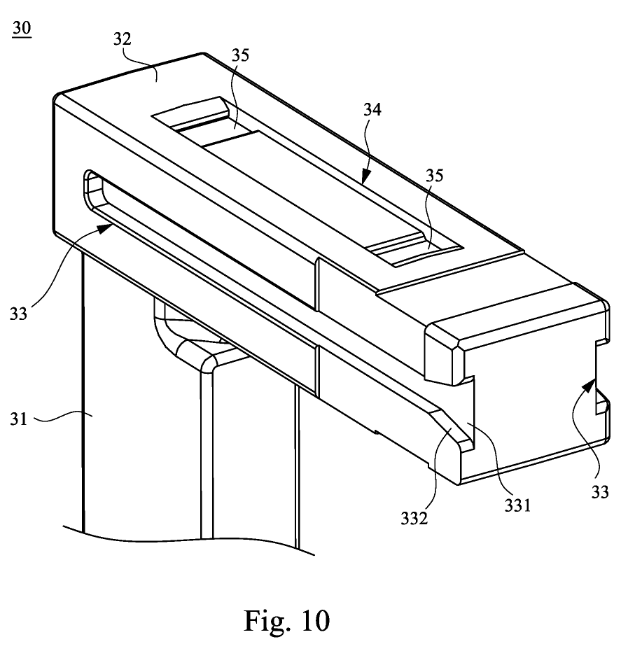

Please refer to FIG. 10, in some embodiments, a bottom surface of the sliding member 32 of the ground pin 30 is provided with a moving groove 34 and one or more positioning grooves 35. Please refer to FIG. 3 and FIG. 6, the bent portion 52 of the flat spring 50 is movably disposed in the moving groove 34. Specifically, the moving groove 34 of the sliding member 32 and the receiving groove 21 of the base 20 both extend along the first direction D1. When the sliding member 32 moves along the first direction D1 in the receiving groove 21, the bent portion 52 correspondingly moves along the opposite direction of the first direction D1 in the moving groove 34. When the sliding member 32 moves along the opposite direction of the first direction D1 in the receiving groove 21, the bent portion 52 correspondingly moves along the first direction D1 in the moving groove 34. Please refer to FIG. 3, FIG. 6, and FIG. 10, when the number of the positioning groove 35 is one, the positioning groove 35 is located at an end of the moving groove 34 and is configured to position the bent portion 52. For example, the positioning groove 35 is located at an end of the moving groove 34 away from the ground member 31, and the flat spring 50, the first fixing hole 261, and the second fixing hole 262 are disposed adjacent to the opening 23 of the receiving groove 21. Thus, when the positioning groove 35 positions the bent portion 52 at the end of the moving groove 34, the ground pin 30 is positioned in the extended position. For another example, the positioning groove 35 is located at an end of the moving groove 34 close to the ground member 31, and the flat spring 50, the first fixing hole 261, and the second fixing hole 262 are disposed adjacent to the opening 23 of the receiving groove 21. Thus, when the positioning groove 35 positions the bent portion 52 at the end of the moving groove 34, the ground pin 30 is positioned in the retracted position. When there are two positioning grooves 35, the two positioning grooves 35 are respectively located at two ends of the moving groove 34. The flat spring 50, the first fixing hole 261, and the second fixing hole 262 are disposed adjacent to the opening 23 of the receiving groove 21. The two positioning grooves 35 are respectively configured to position the ground pin 30 in the extended position and the retracted position.

Please refer to FIG. 10, in an embodiment, a depth of each positioning groove 35 is greater than a depth of the moving groove 34. Specifically, please refer to FIG. 3, FIG. 6, and FIG. 8, the depth of the moving groove 34 is less than a maximum vertical distance between the bent portion 52 and the body 51. The depth of each positioning groove 35 is substantially equal to or slightly smaller than the maximum vertical distance between the bent portion 52 and the body 51. When the bent portion 52 moves in the moving groove 34, a bottom surface of the moving groove 34 deforms the bent portion 52, so that the bent portion 52 accumulates deformation pressure. When the bent portion 52 moves into the positioning groove 35, the bent portion 52 releases most or all of the deformation pressure, substantially returns to its original shape, and engages with the positioning groove 35. In this way, the flat spring 50 can not only position the ground pin 30, but also provide appropriate resistance when the user moves the ground pin 30 to enhance user’s operating feel. Please refer to FIG. 3 and FIG. 6, in an embodiment, the bent portion 52 of the flat spring 50 may abut against a bottom of the positioning groove 35 to enhance positioning stability.

Please refer to FIG. 2, FIG. 7, and FIG. 10, in an embodiment, at least one sidewall of the receiving groove 21 is provided with at least one slider 24. The sliding member 32 of the ground pin 30 is provided with at least one chute 33 corresponding to the at least one slider 24. The chute 33 extends along the first direction D1, and the slider 24 slides within the chute 33, so that the ground pin 30 slides relative to the base 20 along the first direction D1 or the opposite direction thereof. The slider 24 and the chute 33 restrict movement of the ground pin 30 in a second direction D2. The slider 24 and the chute 33 are configured to make the sliding member 32 press the flat spring 50, thereby limiting movement of the flat spring 50 in the second direction D2 and preventing the sliding member 32 from being lifted by the flat spring 50. If the slider 24 and the chute 33 are not provided, the sliding member 32 will be lifted by the flat spring 50 and contact a cover 60 of the power plug 10. When the base 20 and the cover 60 are ultrasonically welded together, ultrasonic waves will melt a portion of the cover 60 that is contacted by the sliding member 32.

Please refer to FIG. 10, in an embodiment, the chute 33 has an open end 331. Two opposite sidewalls 332 of the chute 33 are inclined outward at the open end 331, so that a width of the chute 33 at the open end 331 gradually increases in the first direction D1, thereby facilitating the slider 24 to enter the chute 33.

Please refer to FIG. 10, in an embodiment, the sliding member 32 is provided with two chutes 33. The two chutes 33 are respectively disposed on two opposite side surfaces of the sliding member 32. Please refer to FIG. 8, the receiving groove 21 is provided with two sliders 24, and the two sliders 24 are respectively disposed on two opposite sidewalls of the receiving groove 21. Please refer to FIG. 7, the two sliders 24 slide within the two chutes 33, respectively. In an embodiment, the two sliders 24 are disposed adjacent to the opening 23 and respectively correspond to the first fixing hole 261 and the second fixing hole 262 in the second direction D2, so that the two sliders 24 correspond to the flat spring 50 in the second direction D2, thereby enhancing an effect of the sliding member 32 pressing the flat spring 50.

As shown in FIG. 2, in an embodiment, the receiving groove 21 is provided with four sliders 24. Each of the two opposite sidewalls of the receiving groove 21 is provided with two independent sliders 24 to more evenly restrict the movement of each portion of the sliding member 32 along the second direction D2.

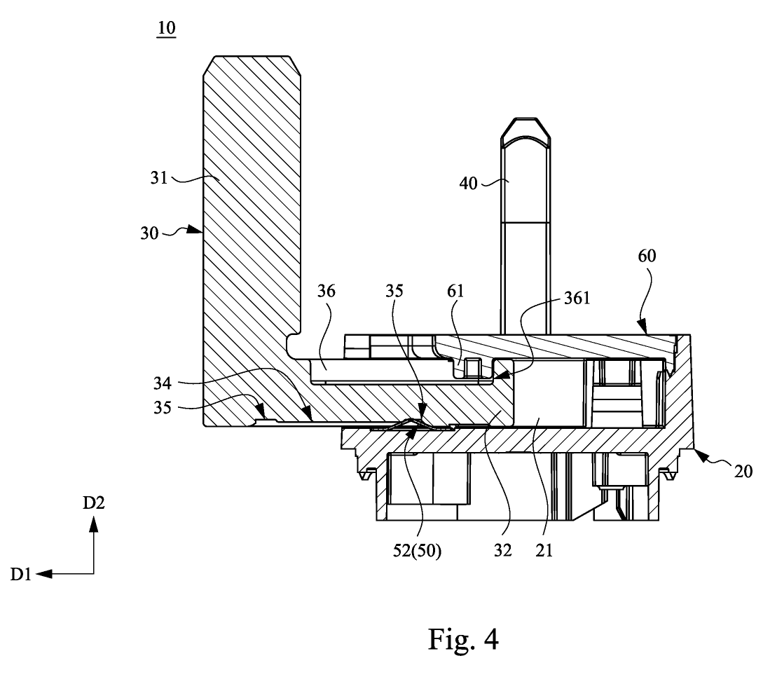

Please refer to FIG. 2, FIG. 5, and FIG. 6, in an embodiment, the power plug 10 further includes the cover 60. The cover 60 is disposed on the base 20 and covers the sliding member 32 of the ground pin 30 located in the receiving groove 21. Please refer to FIG. 2, FIG. 4, and FIG. 6, a bottom surface of the cover 60 (i.e., a surface of the cover 60 facing the base 20) is provided with a limiting member 61. The limiting member 61 may be a protrusion protruding from the bottom surface of the cover 60. A top surface of the sliding member 32 (i.e., a surface of the sliding member 32 facing the cover 60) is provided with a limiting groove 36. The limiting member 61 is movably disposed in the limiting groove 36 to prevent the sliding member 32 from leaving the receiving groove 21 along the first direction D1. Specifically, when the limiting member 61 contacts an end 361 of the limiting groove 36 away from the ground member 31, the sliding member 32 cannot continue to move along the first direction D1, thereby preventing the ground pin 30 from being separated from the base 20. In this embodiment, the cover 60 may have two through holes 65, and the two power pins 40 respectively pass through the two through holes 65. The base 20 and the cover 60 may be made of an insulating material. The base 20 and the cover 60 may be combined by ultrasonic welding.

The embodiments are described in detail above, so that those skilled in the art can fully understand the concept of the present invention. However, the embodiments are not intended to limit the present invention. Those skilled in the art may modify the technical solutions in the embodiments, or replace one or more technical features in the embodiments with equivalents. These modifications or equivalent replacements shall fall within the scope of the present invention. Therefore, the scope of the present invention is determined by the appended claims.

What is claimed is:

1. A power plug, comprising:
a base provided with a receiving groove, wherein a bottom of the receiving groove is provided with a first fixing hole and a second fixing hole;
a flat spring disposed in the receiving groove and comprising a body, a first fixing sheet, and a second fixing sheet, wherein the body comprises two through holes and a bent portion located between the two through holes and protruding in a direction away from the base, the first fixing sheet and the second fixing sheet respectively extend from a first side and a second side of the body toward the base and respectively abut against a sidewall of the first fixing hole and a sidewall of the second fixing hole, and the first side and the second side are opposite sides of the body; and
a ground pin comprising a ground member and a sliding member, wherein the sliding member is movably disposed in the receiving groove and contacts the flat spring.

2. The power plug of claim 1, wherein an angle between the first fixing sheet and the body and an angle between the second fixing sheet and the body are greater than 90 degrees and less than or equal to 110 degrees.

3. The power plug of claim 1, wherein the flat spring further comprises a first locking sheet and a second locking sheet, the first locking sheet and the second locking sheet extend from a third side of the body toward the base and respectively abut against the sidewall of the first fixing hole and the sidewall of the second fixing hole, and the third side is connected between the first side and the second side.

4. The power plug of claim 3, wherein the first locking sheet is substantially parallel to the sidewall of the first fixing hole, and the second locking sheet is substantially parallel to the sidewall of the second fixing hole.

5. The power plug of claim 1, wherein a sidewall of the receiving groove is provided with a slider, and the sliding member is provided with a chute corresponding to the slider.

6. The power plug of claim 5, wherein the chute has an open end, and two opposite sidewalls of the chute are inclined outward at the open end.

7. The power plug of claim 1, wherein a length of the two through holes is substantially the same as a distance between two opposite ends of the bent portion.

8. The power plug of claim 1, wherein a bottom surface of the sliding member is provided with a moving groove and a positioning groove, the bent portion of the flat spring is movably disposed in the moving groove, and the positioning groove is located at an end of the moving groove and is configured to position the bent portion at the end of the moving groove.

9. The power plug of claim 8, wherein a depth of the positioning groove is greater than a depth of the moving groove.

10. The power plug of claim 9, wherein the depth of the moving groove is less than a maximum vertical distance between the bent portion and the body, and the depth of the positioning groove is substantially equal to the maximum vertical distance.

11. The power plug of claim 9, wherein the bent portion abuts against a bottom of the positioning groove.

12. The power plug of claim 1, further comprising:
a cover disposed on the base and covering the sliding member located in the receiving groove, wherein a bottom surface of the cover is provided with a limiting member, a top surface of the sliding member is provided with a limiting groove, and the limiting member is movably disposed in the limiting groove.

13. The power plug of claim 1, wherein the ground member is connected to an end of the sliding member and is substantially perpendicular to the sliding member.

14. The power plug of claim 1, wherein a distance between the first side and the second side of the body is equal to a distance between the sidewall of the first fixing hole and the sidewall of the second fixing hole.

15. The power plug of claim 1, wherein the bent portion includes two inclined portions connected to each other, and an angle between the two inclined portions is an obtuse angle.
